(19) United States
(12) Patent Application Publication
(10) Pub. No.: US 2021/0081921 A1
(43) Pub. Date: Mar. 18, 2021

(54) INFORMATION PROCESSING METHOD, INFORMATION PROCESSING APPARATUS, COMPUTER-READABLE NON-TRANSITORY STORAGE MEDIUM STORING PROGRAM AND INFORMATION PROCESSING TERMINAL

(71) Applicant: Mercari, Inc., Tokyo (JP)

(72) Inventors: Kan MIZUNO, Tokyo (JP); Masato YAMAMOTO, Tokyo (JP); Kazuho NAKAJIMA, Tokyo (JP); Yasuyuki MATSUOKA, Tokyo (JP); Yuuka YAMAJI, Tokyo (JP); Koki KUSANO, Tokyo (JP); Zhen CAO, Tokyo (JP); Nobuo SUZUKI, Tokyo (JP); Hisatomo YAMAMOTO, Tokyo (JP)

(21) Appl. No.: 17/019,935

(22) Filed: Sep. 14, 2020

(30) Foreign Application Priority Data
Sep. 17, 2019 (JP) 2019-168153

(51) Int. Cl. G06Q 20/24; G06Q 40/02; G06Q 20/40

(52) U.S. Cl. CPC G06Q 20/24; G06Q 20/405; G06Q 40/02

(57) ABSTRACT

An information processing method to be executed by an information processing apparatus includes providing a deferred payment service that includes a lump-sum payment to be liquidated in lump-sum within a predetermined period, and multiple times of payments to be liquidated respectively on a plurality of dates including a date within the predetermined period and dates after the predetermined period; receiving information of a first maximum amount to be liquidated by the deferred payment service within the predetermined period, designated by a user; and setting a second maximum amount, to be liquidated by one payment of the multiple times of payments, below the first maximum amount.

### BACKGROUND OF THE INVENTION

### 1. Field of the Invention

The disclosures herein relate to an information processing method, an information processing apparatus, a computer-readable non-transitory storage medium storing program, and an information processing terminal.

### 2. Description of the Related Art

A technique, for deferred payment with credit, is known, which is capable of performing liquidation (payment, repayment) by a method designated by a user among a plurality of deferred payment methods such as multiple times of payments (for example, including revolving credit and installment credit), and a lump-sum payment. For example, see Japanese Patent Application Publication No. 2005-174033 (Patent Literature 1).

However, in the conventional technique, for example, there is a problem that, if a user uses a plurality of deferred payment methods in combination, an amount of monthly liquidation may exceed the user's budget.

### SUMMARY OF THE INVENTION

It is a general object of the present disclosure to provide a technique capable of optimizing an amount of liquidation for a user within a predetermined period when the user uses a plurality of deferred payment methods together.

According to an embodiment, an information processing method to be executed by an information processing apparatus includes providing a deferred payment service that includes a lump-sum payment to be liquidated in lump-sum within a predetermined period, and multiple times of payments to be liquidated respectively on a plurality of dates including a date within the predetermined period and dates after the predetermined period; receiving information of a first maximum amount to be liquidated by the deferred payment service within the predetermined period, designated by a user; and setting a second maximum amount, to be liquidated by one payment of the multiple times of payments, at or below the first maximum amount.

### BRIEF DESCRIPTION OF THE DRAWINGS

Other objects and further features of the present invention will be apparent from the following detailed description when read in conjunction with the accompanying drawings, in which:

FIG. 1 is a drawing showing a configuration of a communication system according to an embodiment of the present disclosure:

FIG. 2 is a drawing showing an example of a hardware configuration of an information processing apparatus according to an embodiment:

FIG. 3 is a drawing showing an example of a block diagram showing configurations of a server and a terminal according to an embodiment:

FIG. 4 is a drawing showing an example of a sequence of a deferred payment setting process of the communication system according to an embodiment:

FIG. 5A is a drawing showing an example of user information stored in the user information storage unit according to an embodiment:

FIG. 5B is a drawing showing an example of deferred payment information stored in the deferred payment information storage unit according to an embodiment:

FIG. 6A is a drawing showing an example of a display screen of the terminal according to an embodiment:

FIG. 6B is a drawing showing an example of a display screen of the terminal according to an embodiment:

FIG. 7 is a drawing showing an example of a sequence of a deferred payment use process of the communication system according to an embodiment:

FIG. 8A is a drawing showing an example of product information stored in the product information storage unit according to an embodiment:

FIG. 8B is a drawing showing an example of purchasing/selling information stored in the purchasing/selling information storage unit according to an embodiment:

FIG. 9A is a drawing showing an example of a display screen of the terminal according to an embodiment:

FIG. 9B is a drawing showing an example of a display screen of the terminal according to an embodiment:

FIG. 9C is a drawing showing an example of a display screen of the terminal according to an embodiment: and

FIG. 9D is a drawing showing an example of a display screen of the terminal according to an embodiment.

### DESCRIPTION OF THE PREFERRED EMBODIMENTS

### <Legal Compliance>

When the disclosure of the present specification is implemented, the disclosure is implemented in compliance with laws of each country in which the disclosure is to be implemented. Furthermore, the disclosure of the present specification is implemented with all changes, replacements, transformations, modifications, and corrections that may be made by a person skilled in the art, in order to comply with laws of each country.

In the following, an embodiment of a process of providing a deferred payment service with credit according to the present disclosure will be described with reference to the accompanying drawings.

### <System Configuration>

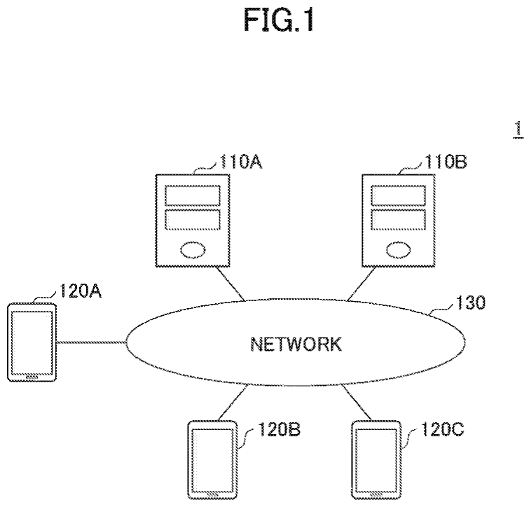

FIG. 1 shows a configuration of a communication system 1 according to an embodiment of the present disclosure. As shown in FIG. 1, in the communication system 1, a server 110A, a server 110B, a terminal 120A, a terminal 120B, and a terminal 120C are connected via a network 130.

In the present disclosure, if it is not necessary to distinguish between the server 110A and the server 110B, the server 110A and the server 110B may be respectively expressed as the server 110. The server 110 is an example of an “information processing apparatus”.

In the present disclosure, if it is not necessary to distinguish among the terminal 120A, the terminal 120B and the terminal 120C, the terminal 120A, the terminal 120B, and the terminal 120C may be respectively expressed as the terminal 120 (an example of an “information processing terminal”).

In the present disclosure, if it is not necessary to distinguish between the server 110 and the terminal 120, the server 110 and the terminal 120 may be respectively expressed as the information processing apparatus 200. The number of the information processing apparatuses 200 connected to the network 130 is not limited to the example of FIG. 1.

The server 110 provides a predetermined service to the terminal 120 used by a user via the network 130 alone or in cooperation with another server. The predetermined service includes, but is not limited to, a settlement service, financial service, electronic commerce service, SNS (Social Networking Service) represented by a messaging service using an instant messenger, content providing service of music, movie, books (including comics, etc.), or the like. The settlement service may include, for example, a settlement service using such as a two-dimensional code, and near field wireless communication. Furthermore, the settlement service may include a deferred payment service by credit (loaning).

The electronic commerce service (transaction service) may include, for example, an internet mail order service, interpersonal transaction service such as a flea market service or online auction service, and an immediate purchase (pawnshop) service. The server 110 may provide a predetermined service to one or more terminals 120 by the predetermined service being used through the terminal 120 by users.

The terminal 120 includes, for example, a smartphone, a tablet, and a personal computer used by the user, and performs a process of using various services provided by the server 110.

A terminal used by a user X will be expressed as a terminal 120X as necessary, and user information in the predetermined service, which is associated with the user X or the terminal 120X will be expressed as user information X as necessary. The user information is the information of a user associated with an account used by the user in the predetermined service. The user information includes, but is not limited to, information associated with the user such as name of the user, an icon image of the user, age of the user, sex of the user, address of the user, preference of the user, and an identifier of the user, balance information of electronic value (electronic money) associated with the user, and credit card information (credit card number, etc.) associated with the user, which is input by the user or provided by the predetermined service, and may be one of these or combination of these.

The network 130 has a role of connecting two or more information processing apparatuses 200. The network 130 means a communication network providing a connection path so that the data can be transmitted and received after the terminal 120 is connected to the server 110.

One or a plurality of portions of the network 130 may be a wired network or a wireless network. The network 130 may include, but is not limited to, an Ad Hoc Network, an intranet, an extranet, a Virtual Private Network (VPN), a Local Area Network (LAN), a Wireless LAN (WLAN), a Wide Area Network (WAN), a Wireless WAN (WWAN), a Metropolitan Area Network (MAN), part of the Internet, part of a Public Switched Telephone Network (PSTN), a mobile phone network, ISDNs (Integrated Service Digital Networks), wireless LANs, LTE (Long Term Evolution), CDMA (Code Division Multiple Access), Bluetooth®, satellite communication, or the like, or combination of two or more of these. The Network 130 may include one or a plurality of networks.

The information processing apparatus 200 may be any information processing apparatus if the information processing apparatus can realize processing, functions, and methods described in the present disclosure.

The information processing apparatus 200 includes, but is not limited to, a smartphone, a mobile phone (feature phone), a computer (including, but not limited to, a desktop, a laptop, a tablet, etc.), a server device, a media computer platform (including, but is not limited to, a cable, a satellite set-top box, a digital video recorder, etc.), a handheld computing device (including, but not limited to, PDA (Personal Digital Assistant), an e-mail client, etc.), a wearable terminal (including, but is not limited to, a glasses-type device, a watch-type device, etc.), other kinds of computers, or a communication platform.

### <Hardware Configuration>

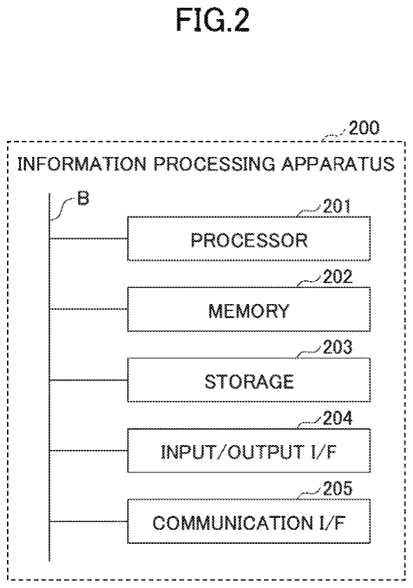

A hardware configuration of the information processing apparatus 200 included in the communication system 1 will be described with reference to FIG. 2. FIG. 2 shows an example of a hardware configuration of an information processing apparatus according to an embodiment.

The information processing apparatus 200 includes a processor 201, a memory 202, a storage 203, an input/output interface (input/output I/F) 204, and a communication interface (communication I/F) 205. The respective components of the hardware of the information processing apparatus 200 are connected to, but is not limited to, each other via a bus B.

The information processing apparatus 200 realizes processing, functions, and/or methods described in the present disclosure in coordination with the processor 201, the memory 202, the storage 203, the input/output I/F 204, and the communication I/F 205.

The processor 201 executes processing, functions, and/or methods realized by codes or instructions included in a program stored in the storage 203. The processor 201 includes, but is not limited to, a central processing unit (CPU), an MPU (Micro Processing Unit), a GPU (Graphics Processing Unit), a microprocessor, a processor core, a multiprocessor, an ASIC (Application-Specific Integrated Circuit), an FPGA (Field Programmable Gate Array), or the like, and may realize respective processes disclosed in the respective embodiments by a logical circuit (hardware) or a dedicated circuit which is formed on an integrated circuit (IC) chip, LSI (Large Scale Integration), or the like. Furthermore, these circuits may be realized by one or a plurality of integrated circuits, or a plurality of processes indicated in the respective embodiments may be realized by a single integrated circuit. Furthermore, the LSI may be referred to as a VLSI, a super LSI, an ultra LSI, or the like, depending on the degree of integration.

The memory 202 temporarily stores a program loaded from the storage 203 and provides a work area for the processor 201. The memory 202 also temporarily stores various kinds of data generated while the processor 201 executes the program. The memory 202 includes, but is not limited to, a RAM (Random Access Memory), a ROM (Read Only Memory), or the like.

The storage 203 stores the program. The storage 203 includes, but is not limited to, an HDD (Hard Disk Drive), an SSD (Solid State Drive), a flash memory, or the like.

The communication I/F 205 performs transmission and reception of various kinds of data via the network 130. The communication may be executed by wire or wireless, and any communication protocol may be used as long as mutual communication can be performed. The communication I/F 205 executes communication with another information processing apparatus via the network 130. The communication I/F 205 transmits various data to another information processing apparatus in accordance with an instruction from the processor 201. Furthermore, the communication I/F 205 receives various kinds of data transmitted from another information processing apparatus and transfers the data to the processor 201.

The input/output I/F 204 includes an input device that inputs various kinds of operations to the information processing apparatus 200 and an output device that outputs a processing result processed by the information processing apparatus 200. The input/output I/F 204 may be a device in which an input device and an output device are integrated or may be an input device and an output device that are separated.

The input device is realized by one or combination of any of all types of devices which can accept an input from a user and transfer information related to the input to the processor 201. The input device includes, but is not limited to, a hardware key such as a touch panel, a touch display, and a keyboard, a pointing device such as a mouse, a camera (operation input via an image), and a microphone (operation input by voice).

The output device is realized by one or combination of all types of devices which can output a processing result processed by the processor 201. If the processing result is output as an image or a moving image, the output device is realized by one or combination of all types of devices which can display the display data in accordance with the display data written in a frame buffer. The output device includes, but is not limited to, a touch panel, a touch display, a monitor (including, but is not limited to, a liquid crystal display, an OELD (Organic Electroluminescence Display), etc.), a head mounted display (HMD), projection mapping, a hologram, a device capable of displaying an image, text information, etc., in the air (may be a vacuum) or the like, a speaker (voice output), a printer, or the like. These output devices may be capable of displaying the display data in 3D.

The program of each embodiment of the present disclosure may be provided in a state of being stored in a computer-readable storage medium. The storage medium can store the program on a “non-transitory tangible medium”. The program includes, but is not limited to, a software program and a computer program.

The storage medium may include, if appropriate, one or a plurality of semiconductor-based integrated circuits or other integrated circuits (ICs) (including, but is not limited to, a field programmable gate array (FPGA), an application specific IC (ASIC), etc.), a hard disk drive (HDD), a hybrid hard drive (HHD), an optical disk, an optical disk drive (ODD), a magneto-optical disk, a magneto-optical drive, a floppy diskette, a floppy disk drive (FDD), a magnetic tape, a solid state drive (SSD), a RAM drive, a secure digital card or drive, any other appropriate storage medium, or any appropriate combination of two or more of these. The storage medium may be, if appropriate, volatile, non-volatile, or combination of volatile and non-volatile.

Furthermore, the program of the present disclosure may be provided to the information processing apparatus 200 via any transmission medium (such as a communication network, broadcast wave) capable of transmitting the program.

Furthermore, each embodiment of the present disclosure may be realized in a form of a data signal embedded in a carrier wave in which a program is embodied by electronic transmission.

The program of the present disclosure is implemented by using methods including, but is not limited to, script languages such as JavaScript®, Python, C language, Go language, Swift, Kotlin, Java®, or the like.

At least part of the processing in the information processing apparatus 200 may be realized by cloud computing which is configured by one or more computers.

At least part of the processing in the information processing apparatus 200 may be performed by another information processing apparatus. In this case, at least part of the processing realized by the processor 201 may be performed by another information processing apparatus.

### <Other>

Unless explicitly stated, a configuration with respect to the determination in embodiments of the present disclosure is not essential, and predetermined processing may be performed when the determination condition is satisfied, or predetermined processing may be performed when the determination condition is not satisfied.

In the present disclosure, unless explicitly stated, or unless indicated by context, “at least one of A and B” means “A, B, or both”. Furthermore, unless explicitly stated, or unless indicated by context, “a”, “an”, or “the” means “one or a plurality of”. Therefore, in the present specification, unless explicitly stated specifically, or unless indicated by context, “an A” or “the A” means “one or a plurality of A”.

The present disclosure incorporates all changes, replacements, transformations, modifications, and corrections that may be made by a person skilled in the art for embodiments and examples of the present disclosure. Furthermore, the attached claims incorporate all changes, replacements, transformations, modifications, and corrections that may be made by a person skilled in the art for embodiments and examples of the present disclosure. Furthermore, the present disclosure incorporates any combination of one or a plurality of features of embodiments or examples of the present disclosure and one or a plurality of features of other embodiments or examples of the present disclosure that may be made by a person skilled in the art.

In addition, a reference within the attached claims for an apparatus or a system, or components of an apparatus or a system which is adapted, is disposed, has ability, is configured, can be used, can operate to perform specific processing, functions, or methods incorporates the apparatus, the system, or the components regardless of whether or not the apparatus, the system, the components or the specific function is activated, turned on, or unlocked, as long as the apparatus, the system, or the component is adapted, is disposed, has ability, is configured, can be used, or can operate.

Unless explicitly mentioned, in the present disclosure, an agreement from the user may be acquired in advance or immediately before performing any of the embodiments or examples. Furthermore, the agreement may be comprehensively acquired or may be acquired each time.

### Embodiment

The embodiments of the present disclosure are embodiments which perform settlement by using a deferred payment service. According to the embodiments, for example, convenience for a user using the deferred payment can be improved. Furthermore, for example, since the deferred payment can be used in an appropriate manner, the load on the terminal 120A and the server 110, and the load on the network 130 between the terminal 120A and the server 110 can be reduced as a result.

### Configuration of Embodiment

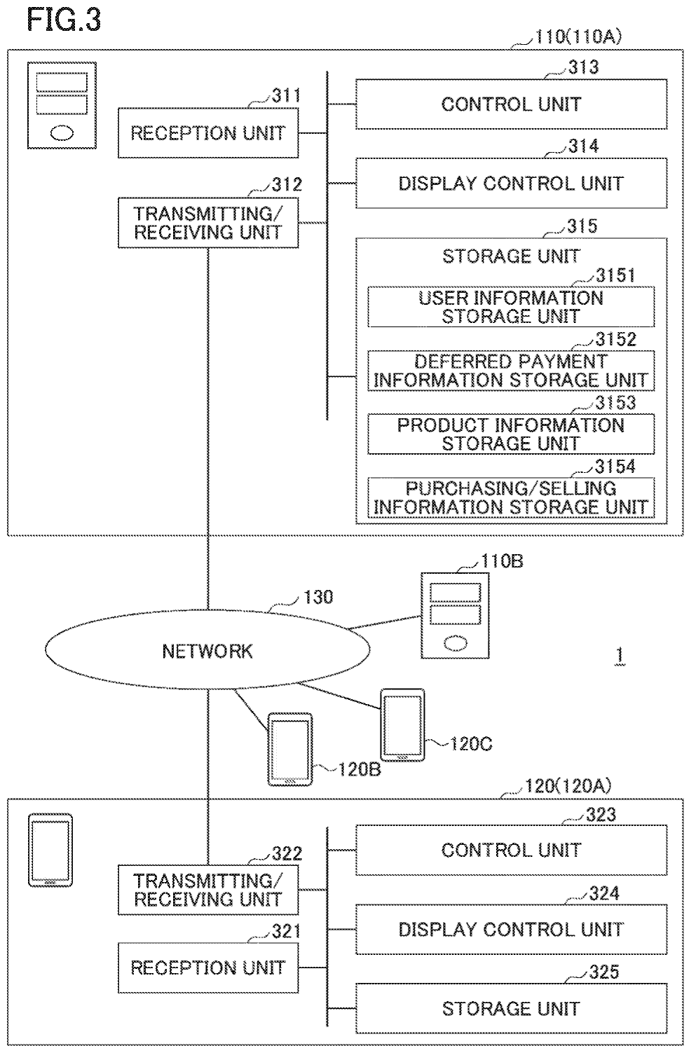

The configuration of the server 110 and the terminal 120 will be described with reference to FIG. 3. FIG. 3 shows an example of a block diagram showing configurations of a server 110 and a terminal 120 according to an embodiment. Each unit disclosed in FIG. 3 is realized in coordination with the processor 201, the memory 202, the storage 203, the input/output I/F 204, and the communication I/F 205 provided in the information processing apparatus 200.

(1) Configuration of Server

The server 110 includes a reception unit 311, a transmitting/receiving unit 312, a control unit 313, a display control unit 314, and a storage unit 315. The processing, functions, or methods of each unit may be realized by machine learning or AI (Artificial Intelligence) within a feasible range.

The reception unit 311 receives various kinds of setting operations or the like from a business operator who operates various kinds of services provided by the server 110.

The transmitting/receiving unit 312 transmits/receives data to/from the terminal 120 in accordance with an instruction from the control unit 313. For example, the transmitting/receiving unit 312 connects a session for communication with the terminal 120 using HTTPS or the like when a user of the terminal 120 is authenticated by the user ID and the password included in the login request from the terminal 120. Then, the address for communication of the terminal 120 or the like, and the user ID or the like are stored in association with the ID of the connected session for communication. Then, using the connected session for communication, the data is transmitted to the terminal 120 or the like.

The control unit 313 performs a process of providing various kinds of services such as an electronic commerce service and settlement service to a user of the terminal 120.

The display control unit 314 causes the transmitting/receiving unit 312 to transmit information for controlling the display screen of the terminal 120 or the like in accordance with an instruction of the control unit 313.

The storage unit 315 includes a user information storage unit 3151 that stores user information, a deferred payment information storage unit 3152 that stores deferred payment information, a product information storage unit 3153 that stores information of products purchased by using multiple times of payments, and a purchasing/selling information storage unit 3154 that stores information of products purchased/sold in the transaction service.

(2) Configuration of Terminal

The terminal 120 includes a reception unit 321, a transmitting/receiving unit 322, a control unit 323, a display control unit 324, and a storage unit 325. The processing, functions, or methods of each unit may be realized by machine learning or AI within a feasible range.

The reception unit 321 receives various kinds of operations or the like from a user of the terminal 120.

The transmitting/receiving unit 322 transmits/receives data to/from the server 110 or the like in accordance with an instruction from the control unit 323. For example, the transmitting/receiving unit 322 connects a session for communication with the server 110 using HTTPS or the like when logged in to the server 110. Then, the address for communication of the server 110 or the like is stored in association with the ID of the connected session for communication. Then, using the connected session for communication, the data is transmitted to the server 110.

The control unit 323 performs a process of using various kinds of services provided by the server 110. The display control unit 324 controls the display screen of the terminal 120 based on the information received from the server 110 in accordance with an instruction of the control unit 323. The storage unit 325 stores information for using services or the like provided by the server 110.

### <Processing of Embodiment>

### <<Deferred Payment Setting Process>>

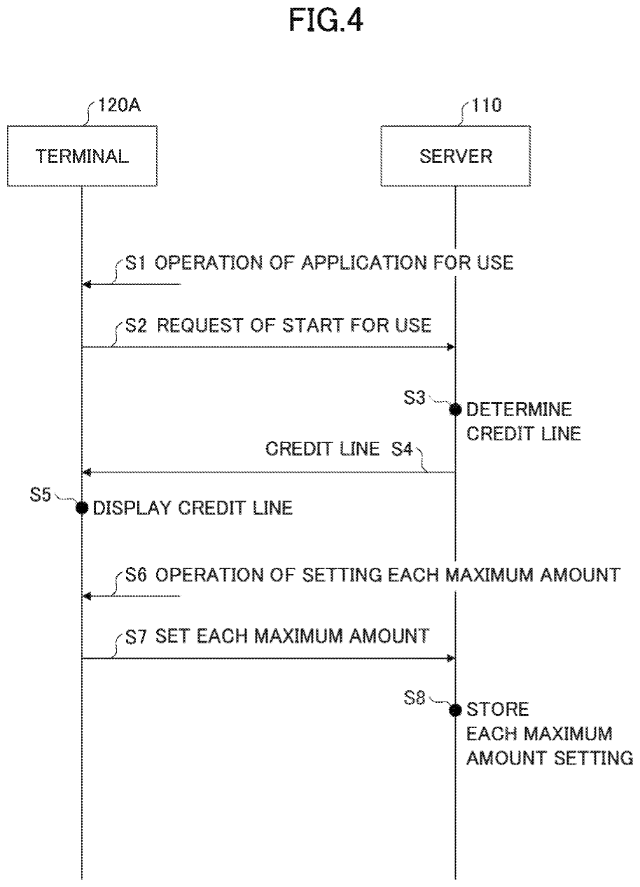

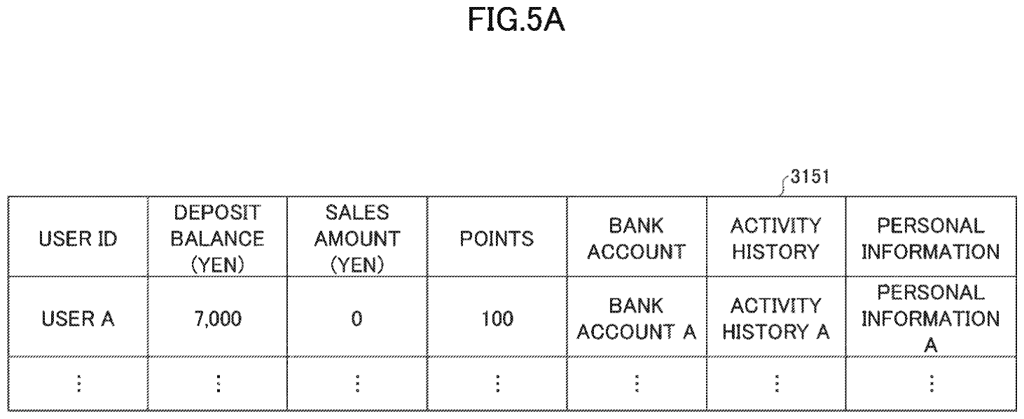

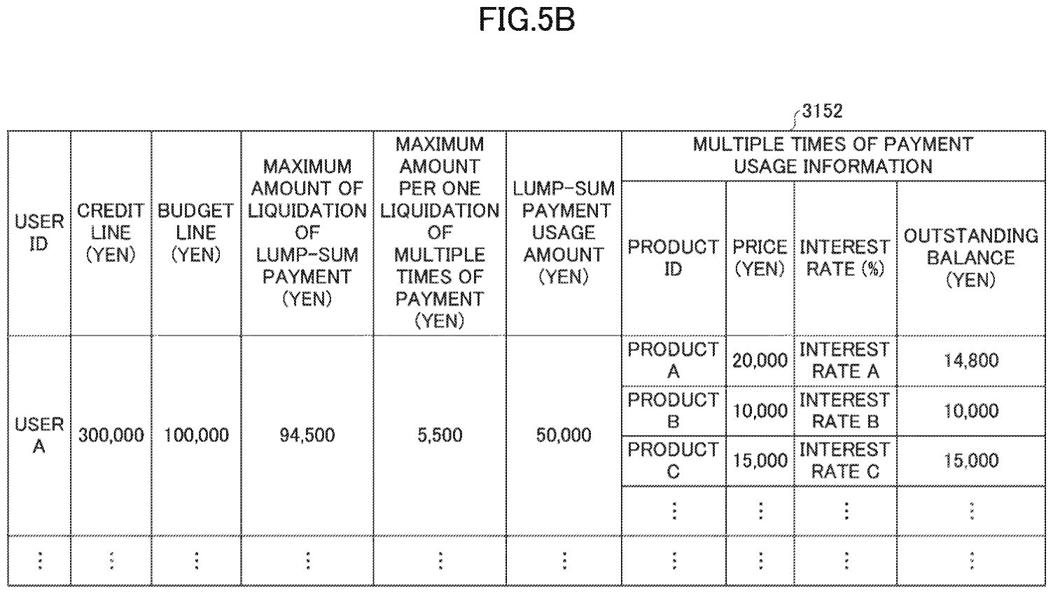

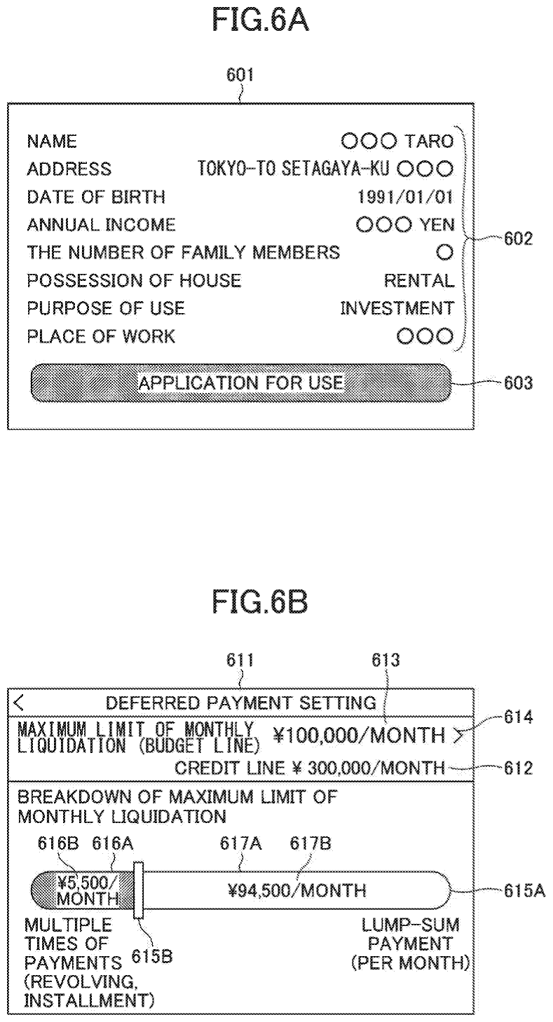

An example of a deferred payment setting process of the communication system 1 according to an embodiment will be described with reference to FIG. 4 to FIG. 6B. FIG. 4 shows an example of a sequence of a deferred payment setting process of the communication system 1 according to an embodiment. FIG. 5A shows an example of user information stored in the user information storage unit 3151 according to an embodiment. FIG. 5B shows an example of deferred payment information stored in the deferred payment information storage unit 3152 according to an embodiment. FIG. 6A and FIG. 6B show an example of a display screen of the terminal 120 according to an embodiment. The terminal 120A is assumed to have been authenticated by the server 110 using the account of User A when communicating with the server 110.

In step S1, the terminal 120A receives an operation for starting using the deferred payment service provided by the server 110 (operation of application for use) from User A. The terminal 120A may accept an input operation of the personal information of User A. The personal information to be input may include information such as name, address, date of birth, annual income, family relationship, possession of a house, place of work (occupation), and the like.

In the example of FIG. 6A, the terminal 120A displays a display area 602 of the personal information input by User A and an “application for use” button 603 on the display screen 601. When the “application for use” button 603 is pressed, the following process is executed.

Subsequently, the terminal 120A transmits a request to start using the deferred payment service to the server 110 (step S2). The request to start using the deferred payment service may include the user ID of User A and the personal information input by User A. The server 110 may acquire the user ID of the terminal 120A based on the ID of the session for communication of the request received from the terminal 120A.

Subsequently, the server 110 refers to, for example, the user information storage unit 3151, and determines the credit line, which is the limit amount of available debt of User A for deferred payment, based on the personal information or the like of User A (step S3).

### (User Information Storage Unit 3151)

In the example of FIG. 5A, the user information storage unit 3151 stores a deposit balance (yen), a sales amount (yen), points, a bank account, an activity history, and personal information in association with the user ID. The user ID is identification information of the user. The deposit balance is, for example, a balance of electronic value topped-up by using a bank, a credit card, a cash register of a store, or the like. The sales amount is, for example, the total amount obtained by subtracting a commission from the price of the product or the like when the user sells the product or the like by using a transaction service provided by the server 110. The points, for example, are given from the server 110 to the user and are available for settlement in settlement service provided by the server 110, liquidation of deferred payment, or the like. Note that one point may be paid for one yen. In the example of FIG. 5A, in the case of User A, the balance which is the amount available for settlement by the user is a total of 7,100 yen because the deposit balance is 7,000 yen, the sales amount is 0 yen, and the points are equal to 100 yen.

For example, the bank account is a deposit account, which is registered by a user, of the user at a bank cooperating with a business operator operating the server 110 and is a bank account capable of such as depositing (topping-up) the balance from the deposit.

The activity history is the activity history of the user. The activity history may include, for example, a history of purchasing/selling products or the like by the user, using the electronic commerce service provided by the server 110, a history of money transfer of the user with other users, and the like. The personal information is personal information of the user. The personal information may include, for example, the information input by User A in the process of step S1.

Furthermore, the server 110 stores the determined credit line in the deferred payment information storage unit 3152.

### (Deferred Payment Information Storage Unit 3152)

In the example of FIG. 5B, the deferred payment information is stored in the deferred payment information storage unit 3152 in association with the user ID. The deferred payment information is the information about the deferred payment service provided by the server 110.

In the example of FIG. 5B, the deferred payment information includes, for example, the user's credit line, budget line, the maximum amount of liquidation of a lump-sum payment, the maximum amount per one liquidation of multiple times of payments (minimum payment), lump-sum payment usage amount, deferred payment information, and the like.

The budget line is the maximum amount to be liquidated (payment, repayment) by the deferred payment service on each predetermined date (for example, the end of every month). The budget line is the total amount of the maximum amount of liquidation of a lump-sum payment and the maximum amount of liquidation of multiple times of payments. For example, the amount of the budget line may be set by a user.

The maximum amount of liquidation of a lump-sum payment is the maximum amount to be liquidated in lump-sum (monthly clear) on each predetermined date (for example, the end of every month). The maximum amount per one liquidation of multiple times of payments is the maximum amount of total amount to be liquidated per one liquidation of revolving credit and installment credit which are liquidated in multiple times on each predetermined date (for example, the end of every month). A minimum amount per one liquidation of multiple times of payments also may be set.

The lump-sum payment usage amount is the total amount settled by using the lump-sum payment within a predetermined period, and the amount to be liquidated in lump-sum on a predetermined date (for example, the end of the next month).

### ((Multiple Times of Payments Usage Information))

Price, an interest rate, and an outstanding balance are associated with the product ID and are stored in the multiple times of payments usage information. Although not shown, the amount that had been liquidated may be stored. The product ID is the identification information of a product purchased by using multiple times of payments. The price is the price of the product. The interest rate is the interest rate of the commission (interest) applied to multiple times of payments for the product. The outstanding balance is the unliquidated balance (principal) of multiple times of payments for the product. A transaction ID that can uniquely identify a transaction may be used instead of the product ID.

In the case of the revolving credit of multiple times of payments, for example, if the outstanding balance of the revolving credit on the next payment date is equal to or more than the “maximum amount per one liquidation of multiple times of payments” set by the user, “maximum amount per one liquidation of multiple times of payments”, which is a fixed amount, is collected from the balance of the user. On the other hand, if the outstanding balance of the revolving credit on the next payment date is less than the “maximum amount per one liquidation of multiple times of payments” set by the user, the outstanding balance is collected from the balance of the user. Furthermore, the principal and the interest rate commission may be included in the outstanding balance.

In the case of the installment credit of multiple times of payments, an amount obtained by dividing the price of the product by the number of payments designated by the user is collected from the balance of the user with a fixed amount on each predetermined date. The designation of multiple times of payments may be designated before the purchase of the product or after the purchase of the product.

The server 110 may prohibit (restrict) the use of new revolving credit by a user who has a predetermined number (for example, three) or more of products for which the debt for revolving credit remains. In this case, the server 110 permits the use of the new revolving credit only once when the debt of revolving credit regarding one of the predetermined number of products is completely liquidated (completed in liquidation). This allows the number of products for which debt of revolving credit remains to be limited, so an inappropriate increase in debt for multiple times of payments may be reduced.

Furthermore, when the server 110 collects the liquidation amount for the revolving credit on a prescribed date, the collected amount may be allocated to the liquidation of the outstanding balance in the order of the product of the highest priority of the liquidation among the products purchased with the revolving credit by the user. This allows, for example, the liquidation status for each product to be displayed (visualized) on the terminal 120, as if each product was paid in installments in order. Consequently, the user is given the feeling of repaying the debt regarding each product as compared with a conventional method for comprehensively repaying the entire debt for revolving credit.

In this case, for example, the server 110 may determine the priority of liquidation to be higher in order of early purchase date and time. This allows the user to be given the feeling of repaying debts in order of purchase. Furthermore, for example, the server 110 may determine the priority of liquidation to be higher in order of high purchase price. This allows the user to be given the feeling of repaying debts in order of price. Furthermore, for example, the server 110 may determine the priority of liquidation to be higher in order of high interest rate of the set revolving credit. This allows, for example, if the product is purchased by revolving credit with a relatively low interest rate by using a campaign or the like set by a business operator of the server 110, the total repayment amount be reduced by postponing liquidation of debt of that product. Furthermore, for example, the server 110 may determine the priority of liquidation to be higher in order of greater gap (difference) between the amount of money based on the transaction price of the product in the transaction service provided by the server 110 and the price when the product is purchased. Furthermore, for example, the server 110 may determine the priority of liquidation to be higher in order of smaller gap between the amount of money based on the transaction price of the product in the transaction service provided by the server 110 and the price when the product is purchased.

Furthermore, when the server 110 collected the liquidation amount for revolving credit on a predetermined date, the server 110 may allocate an equal amount to the liquidation of each product purchased with the revolving credit by the user. This allows that, for example, the cheaper the purchase price is, the earlier the liquidation is completed.

Furthermore, when the server 110 collected the liquidation amount for revolving credit on a predetermined date, the server 110 may respectively allocate an amount corresponding to the price when each product is purchased (for example, the liquidation amount allocated as a percentage of the purchase price of each product), to the liquidation of each product purchased with revolving credit by the user. This allows the liquidation of each product purchased at the same time to be completed at the same time.

The server 110 may calculate the credit rating of the user using the activity history of the user, personal information, and the like, and determine the credit line of the user corresponding to the calculated credit rating. Furthermore, the server 110 may acquire the credit information of the user from the designated credit information agency, and calculate the credit line based on the acquired credit information.

For example, if the calculated credit line is 0 yen, the server 110 may transmit a notification indicating that the deferred payment service is not available for User A to the terminal 120A and display. In this case, the following process is not executed.

The server 110 may use the maximum amount of liquidation of a lump-sum payment set for the user as a limit amount of debt that can be used by the lump-sum payment of the user (a limit amount of lump-sum payment). In this regard, in the example of the information stored in the deferred payment information storage unit 3152 of FIG. 5B, the limit amount of lump-sum payment of User A is 94,500 yen.

Furthermore, when the request of deferred payment in which an amount of lump-sum payment exceeds the maximum amount of liquidation of a lump-sum payment is received from the terminal 120A, the server 110 may return an error response to the terminal 120A indicating deferred payment in lump-sum payment is not available due to exceeding the limit amount.

Furthermore, when the request of deferred payment in which an amount of lump-sum payment exceeds the maximum amount of liquidation of a lump-sum payment is received from the terminal 120A, the server 110 may automatically allow the amount exceeding the limit amount to be multiple times of payments.

Furthermore, the server 110 may set the amount obtained by subtracting the budget line set for User A from the credit line as the limit amount of debt that can be used in multiple times of payments. In this regard, in the example of the information stored in the deferred payment information storage unit 3152 of FIG. 5B, the limit amount of debt of user A available for the multiple times of payments is set as 200,000 yen (=300,000 yen−100,000 yen).

When the request of deferred payment in which the debt of the remaining amount of multiple times of payments exceeds the limit amount is received from the terminal 120A, the server 110 may return an error response to the terminal 120A indicating deferred payment in multiple times of payments is not available due to exceeding the limit amount. This allows using both a lump-sum payment and multiple times of payments appropriately in accordance with a credit line determined by the server 110 and a budget line set for the user.

Subsequently, the server 110 transmits information of the determined credit line to the terminal 120A (step S4). Subsequently, the terminal 120A displays the received credit line information on the screen (step S5). Subsequently, the terminal 120A receives from User A an operation of designating at least one of the budget line, the maximum amount of liquidation of a lump-sum payment, and the maximum amount of liquidation of multiple times of payments (step S6).

In the example of FIG. 6B, the terminal 120A displays a credit line 612 determined by the server 110 and a budget line 613 set for the user on the display screen 611. A display screen for changing the amount of the budget line 613 is displayed when the button 614 is pressed.

Furthermore, in the example of FIG. 6B, the terminal 120A also displays a boundary 615B of a gauge 615A, an area 616A indicating a maximum amount of liquidation of multiple times of payments set for the user, and an area 617A indicating a maximum amount of liquidation of a lump-sum payment. The terminal 120A changes the ratio of the extent of area 616A indicating the maximum amount of liquidation of multiple times of payments and the ratio of the extent of area 617A indicating the maximum amount of liquidation of a lump-sum payment, regarding the extent of the gauge 615A, by operation of swiping the boundary 615B of the gauge 615A to left and right. The server 110 may set the ratio of the maximum amount of liquidation of multiple times of payments regarding the budget line only equal to or less than a predetermined ratio (for example, 50%). Thereby, for example, it is prevented that a predetermined ratio or more of the amount of monthly liquidation is allocated to multiple times of payments. This allows, for example, the user to appropriately use a lump-sum payment and multiple times of payments such as revolving credit in combination. The server 110 may determine the predetermined ratio based on the user information. In this case, the server 110, as the credit rating of the user higher, may determine the predetermined ratio to be higher or may determine the predetermined ratio to be lower.

The ratio of the extent of area 616A indicating the maximum amount of liquidation of multiple times of payments and the ratio of the extent of area 617A indicating the maximum amount of liquidation of a lump-sum payment regarding the extent of the gauge 615A indicates respectively the ratio of the maximum amount of liquidation of multiple times of payments and the ratio of the maximum amount of liquidation of a lump-sum payment regarding the amount of budget line 613. In the example of FIG. 6B, out of 100,000 yen per month of the budget line 613, the maximum amount of liquidation of multiple times of payments 616B is 5,500 yen per month and the maximum amount of liquidation of a lump-sum payment 617B is 94,500 yen per month.

Subsequently, the terminal 120A transmits information of each maximum amount designated by User A to the server 110 (step S7). For example, the terminal 120A transmits information of a budget line, a maximum amount of liquidation of a lump-sum payment, and a maximum amount of liquidation of multiple times of payments, designated for the user, to the server 110.

Subsequently, the server 110 stores each maximum amount designated for User A (step S8). The server 110 stores information of a budget line, a maximum amount of liquidation of a lump-sum payment, and a maximum amount of liquidation of multiple times of payments in the deferred payment information of User A of the user information storage unit 3151.

### <<Deferred Payment Use Process>>

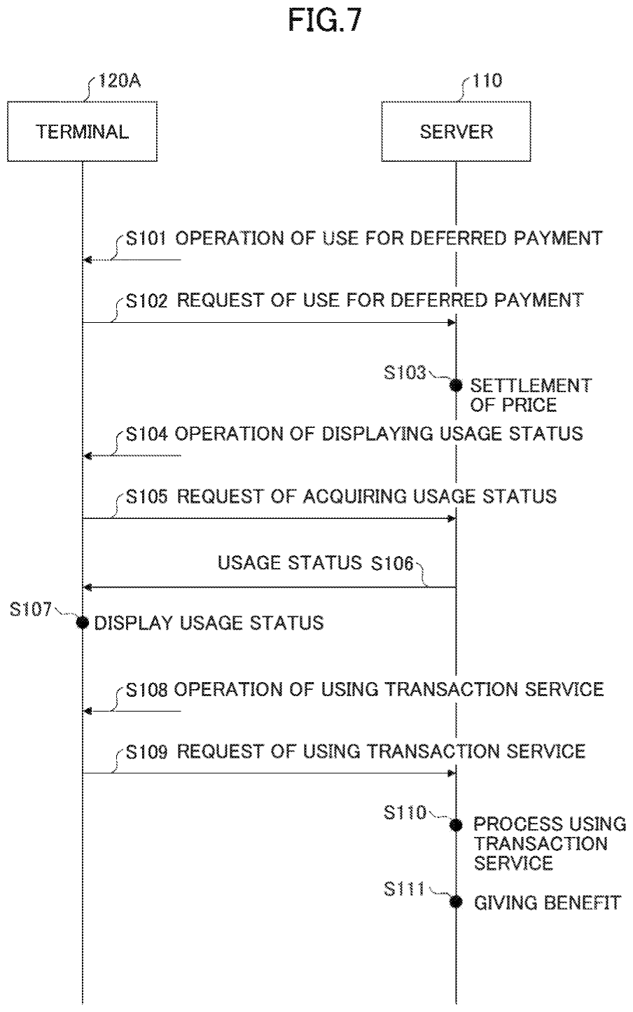

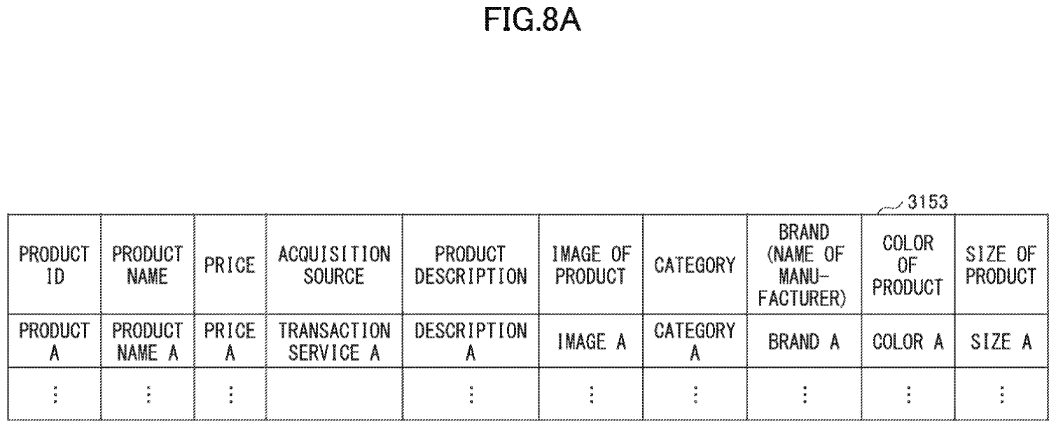

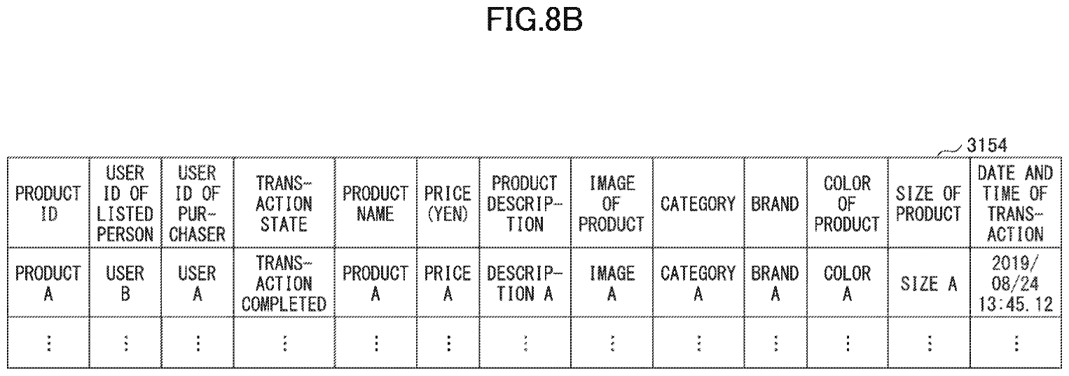

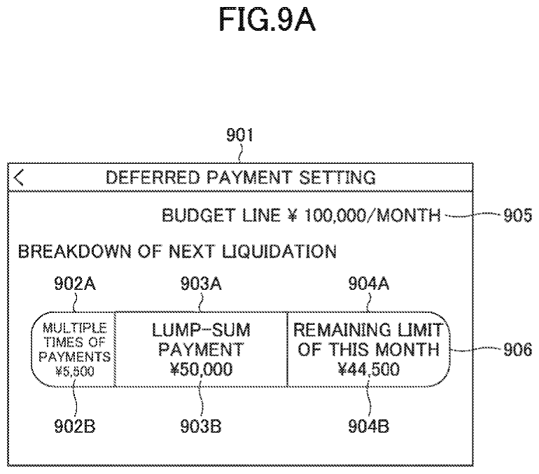

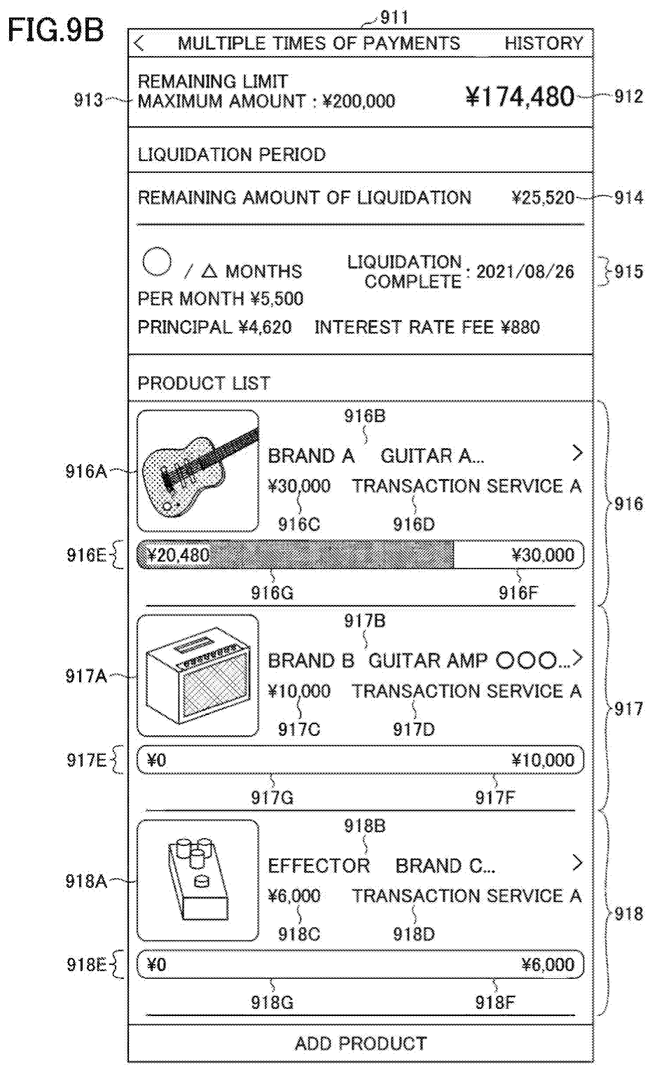

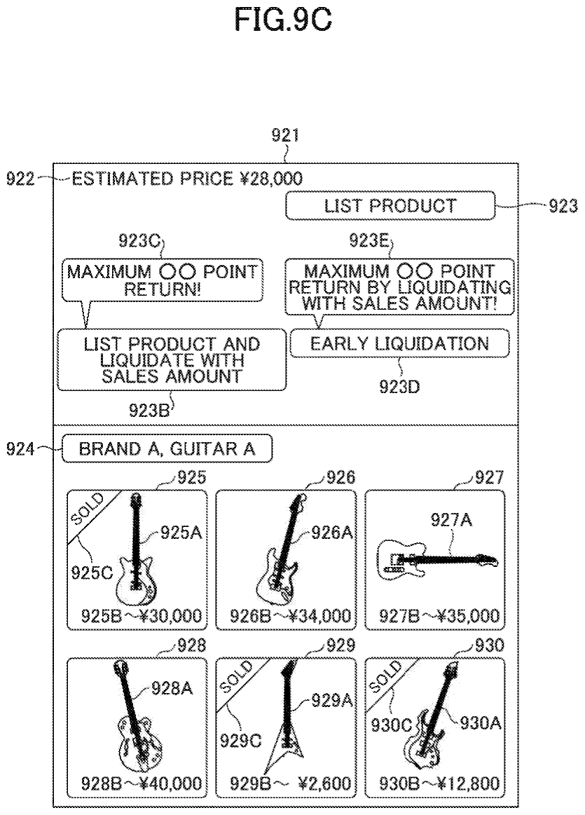

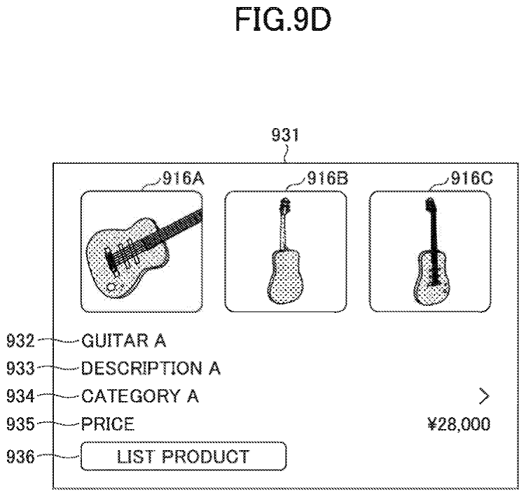

An example of a deferred payment use process of the communication system 1 according to an embodiment will be described with reference to FIG. 7 to FIG. 9D. FIG. 7 shows an example of a sequence of a deferred payment use process of the communication system 1 according to an embodiment. FIG. 8A shows an example of product information stored in the product information storage unit 3153 according to an embodiment. FIG. 8B shows an example of purchasing/selling information stored in the purchasing/selling information storage unit 3154 according to an embodiment. FIG. 9A to FIG. 9D show an example of a display screen of the terminal according to an embodiment. The terminal 120A is authenticated by the server 110 using the account of User A when communicating with the server 110.

### (Deferred Payment Use Process)

In step S101, the terminal 120A receives an operation for purchasing Product A by using deferred payment from User A. The terminal 120A may perform settlement on the website, settlement using a two-dimensional code, settlement using near field communication, and the like, by using a deferred payment method set for User A in advance.

Subsequently, the terminal 120A transmits a request for using deferred payment to the server 110 (step S102). For example, the request for using deferred payment may include a user ID of User A, an amount of settlement, information indicating product A, and information indicating liquidation method in deferred payment.

Subsequently, the server 110 makes settlement for the price of Product A by using deferred payment (step S103). The server 110 stores the deferred payment information of User A in the deferred payment information storage unit 3152. The server 110 may permit the use of multiple times of payments only when the price of the product purchased by User A is equal to or more than a predetermined amount (for example, 10,000 yen). For example, the server 110 may permit settlement of the price using multiple times of payments when the price of the product to be purchased using the transaction service provided by the server 110 is equal to or more than the predetermined amount, and the server 110 may restrict settlement of the price using multiple times of payments when the price is not equal to or more than the predetermined amount.

Furthermore, the server 110 may determine the availability of multiple times of payments based on the category (type) of the product to be purchased. In this case, for example, the server 110 may prohibit the use of multiple times of payments, if the category of the product listed in the transaction service is “food”. Thereby, for example, with respect to a product for which it is difficult to liquidate debt for multiple times of payments by the sales amount of that product, purchasing by multiple times of payments can be restricted. Furthermore, for example, the server 110 may determine availability of multiple times of payments based on the type of store where User A makes settlement. In this case, for example, if the store where User A makes settlement is a restaurant, a convenience store, or the like, the server 110 may prohibit the use of multiple times of payments. In this case, for example, the server 110 may determine the type of the store based on the current position information of the terminal 120A. Alternatively, the server 110 may determine the type of the store based on the ID of the POS terminal that has transmitted the request for using deferred payment or the like.

Furthermore, in the process of step S103, when the multiple times of payments are used for the settlement, the server 110 stores the information of the product purchased by that settlement in the product information storage unit 3153. The server 110 may be configured to be capable of mutually converting debt for lump-sum payment and debt for multiple times of payments by the operation of User A.

### (Product Information Storage Unit 3153)

In the example of FIG. 8A, the product information storage unit 3153 stores, in association with a product ID, a product name, price, a product description, an image of the product, a category, a brand (name of manufacturer), a color of the product, a size of the product, and a release date. A product name, price, a product description, an image of the product, a brand (name of manufacturer), a color of the product, a size of the product, and a release date are respectively the name of the product, price, product description, image of the product, brand (name of manufacturer), color, size, and release date.

The category is, for example, information indicating attributes of products such as women's, baby/kids, books, and games. For example, when User A purchased a product by using a transaction service provided by the server 110, the server 110 may store at least a part of information of the product stored in the purchasing/selling information storage unit 3154 by the seller of the product in association with User A, in the product information storage unit 3153.

The server 110 stores information of the listed product in the purchasing/selling information storage unit 3154 when the product is listed using a transaction service provided by the server 110. Furthermore, the server 110 updates the information stored in the purchasing/selling information storage unit 3154 when listing, purchasing/selling, or the like are performed in the transaction service provided by the server 110.

### (Purchasing/Selling Information Storage Unit 3154)

In the example of FIG. 8B, the purchasing/selling information storage unit 3154 stores, in association with a product ID, a user ID of a seller, a user ID of a purchaser, a product name, price, a product description, an image of the product, a category, a brand, a color of the product, a size of the product, and date and time of transaction.

The product ID is the identification information of a product listed by the user. A transaction state is a state related to the transaction of the product associated with the product ID and may include, for example, “listed”, “in transaction”, “transaction completed”, “suspension of listing”, “canceled by purchaser”, “canceled by operator”, and the like. “Listed” is a state in which any user can purchase the product associated with the product ID. “In transaction” is a state from after the purchase operation is performed by the purchaser until the product shipped by the seller reaches the purchaser and the purchaser completes the receipt operation. “Transaction completed” is a state after the purchaser has performed the operation of completing the receipt. “Suspension of listing” is a state in which the seller canceled the listing. “Canceled by purchaser” is a state in which the purchaser canceled the purchase. “Canceled by operator” is a state in which the purchaser's purchase of such as an illegal listing has been canceled by the operator of the server 110.

A product name, price, a product description, an image of the product, a category, a brand (name of manufacturer), a color of the product, and a size of the product are respectively the name of the product according to the product ID, the price designated by the seller, product description, image of the product, brand (name of manufacturer), color, and size. The date and time of the transaction are the date and time when the purchaser performed the purchase operation.

The server 110 may store the product information registered by User A in the product information storage unit 3153 in association with User A when User A purchases the product at a physical store or the like. In this case, the server 110 may acquire the product information based on the receipt image captured by User A in the terminal 120A.

### (Display of Deferred Payment Usage Status)

Subsequently, the terminal 120A receives an operation for displaying the usage status of deferred payment from User A (step S104). Subsequently, the terminal 120A transmits a request for acquiring the usage status of deferred payment to the server 110 (step S105). Subsequently, the server 110 transmits information for displaying the usage status of deferred payment of User A to the terminal 120A (step S106). Subsequently, the terminal 120A displays information indicating the usage status of deferred payment of User A based on the information received from the server 110 (step S107).

In the example of FIG. 9A, the terminal 120A displays, on the display screen 901 of deferred payment usage status, the budget line 905 set for User A in the process of step S6 in FIG. 4 and the gauge 906 indicating the breakdown of debt for deferred payment required to be liquidated on the next liquidation date.

Furthermore, the terminal 120A displays, on the gauge 906, an area 902A indicating the amount required to be liquidated on the next liquidation date among debt for multiple times of payments, an area 903A indicating the amount of debt for lump-sum payment required to be liquidated on the next liquidation date, and an area 904A indicating the remaining limit until the next liquidation date. The remaining limit until the next liquidation date is the remaining amount which is available for lump-sum payment within a predetermined period and may be the amount obtained by subtracting the used amount for lump-sum payment from the maximum amount of liquidation of a lump-sum payment.

Furthermore, the amount 902B required to be liquidated on the next liquidation date among debt for multiple times of payments is displayed in association with the area 902A. Furthermore, the amount 903B of debt for lump-sum payment required to be liquidated on the next liquidation date is displayed in association with the area 903A. Furthermore, the remaining limit 904B until the next liquidation date is displayed in association with the area 904A.

The terminal 120A may determine the extent of the area 902A, the extent of the area 903A, and the extent of the area 904A in accordance with the amount of money indicated by each area. For example, the terminal 120A may display the extent of the area 902A, the extent of the area 903A, and the extent of the area 904A in an extent corresponding to the ratio of the amount of money indicated by each area.

If the area 902A of FIG. 9A is pressed, or if a predetermined operation is performed from the menu screen of deferred payment or the like, the terminal 120A displays the display screen 911 of multiple times of payments usage status of FIG. 9B.

In the example of FIG. 9B, the terminal 120A displays, on the display screen of multiple times of payments usage status 911, a maximum amount of liquidation of multiple times of payments 913 of User A, a remaining limit of multiple times of payments 912, an outstanding balance for multiple times of payments 914 (debt balance for multiple times of payments). The outstanding balance for multiple times of payments 914 is a total amount of the outstanding balance for each product stored in the multiple times of payments usage information associated with User A in the deferred payment information storage unit 3152. The remaining limit of multiple times of payments 912 is an amount obtained by subtracting the outstanding balance for multiple times of payments 914 from the maximum amount of liquidation of multiple times of payments 903.

Furthermore, in the example of FIG. 9B, the terminal 120A displays, on the area 915, the time when liquidation of multiple times of payments are scheduled to be completed, the maximum amount per one liquidation of multiple times of payments (minimum payment), the breakdown of principal and interest rate fees of the maximum amount per one liquidation of multiple times of payments (minimum payment), and the like. Furthermore, in the example of FIG. 9B, the terminal 120A displays the information of each product purchased by multiple times of payments, on the areas 916, 917, and 918, respectively. In the area 916, an image of Product A 916A purchased by multiple times of payments, product name 916B, the price (original) at the time of purchase 916C, the name of transaction service or the like for which Product A is purchased, and a gauge 916E are displayed. Furthermore, the gauge 916E shows the ratio of the amount that has been liquidated 916G with respect to the amount of debt for multiple times of payments 916F. The area 917 and the area 918 display similar items with the area 916.

If the entire amount of debt for multiple times of payments for one product among the respective products displayed in the area 916, the area 917, and the area 918 is fully liquidated, the area for that product is no longer displayed on the display screen of multiple times of payments usage status 911. A blank area of the number obtained by subtracting the number of products purchased by multiple times of payments but not fully settled from the maximum number of products that can be purchased by multiple times of payments may be displayed. This allows the user to visually recognize how many products can be purchased by multiple times of payments.

If any one of area 916, area 917, and area 918 is pressed by User A, the terminal 120A displays a liquidation screen of multiple times of payments for the product displayed in the pressed area. In the example of FIG. 9C, since the area 916 of FIG. 9B has been pressed, the terminal 120A displays the liquidation screen of multiple times of payments 921 for product A.

In the example of FIG. 9C, the terminal 120A displays the estimated price 922 of Product A on the liquidation screen of multiple times of payments 921 for product A. The estimated price 922 is, for example, the salable price of the product estimated based on the transaction history (purchasing/selling history) in the transaction service. The server 110 may calculate the representative value of the price at which the same product as Product A is purchased by the purchaser, referring to the purchasing/selling information storage unit 3154, and estimate the representative value as the salable price. For example, the server 110 may use an average value, a median, or a mode as the representative value.

The server 110 may determine that the same product as Product A or a product of which the degree of similarity with Product A is equal to or greater than the predetermined threshold is the same kind of product as product A. The server 110 may determine that the product designated by User A and the product stored in the purchasing/selling information storage unit 3154 are the same when both products match a product name, brand, color of the product, and size of the product. Furthermore, for example, the server 110 may determine that the similarity between Product A and the product stored in the purchasing/selling information storage unit 3154 is equal to or greater than the predetermined threshold, when both products have a predetermined relationship which is set in advance regarding a category, and at least a part of the product name and the brand of both products matches. Furthermore, for example, the server 110 may calculate the similarity of both products based on the fixed price of the product, the purchased/sold price in the transaction service, the product name, the brand, the color, the size, or the like, by using AI through which machine learning is performed by deep learning or the like.

Furthermore, in the example of FIG. 9C, the terminal 120A displays, on the liquidation screen of multiple times of payments for product A 921, a “list product” button 923A, a “list product and liquidate with sales amount” button 923B, and an “early liquidation” button 923D. Furthermore, the terminal 120A displays “Maximum ΔΔ points return!” tag 923C in association with the “list product and liquidate with sales amount” button 923B, and “Maximum ΔΔ points return by liquidating with sales amount!” tag 923E in association with the “early liquidation” button 923D.

Furthermore, the terminal 120A displays purchasing/selling information of the same or similar product as Product A in the transaction service. In the example of FIG. 9C, the terminal 120A inputs the name of Product A or the like to the search box 924 and displays a list of results of searching the purchasing/selling information storage unit 3154 based on the input information on the areas 925 to 930 respectively. The area 925 displays an image of the searched product 925A, a purchasing/selling price 925B, and a mark area 925C indicated that if the product has been sold. The areas 926 to 930 display the same kinds of items.

The server 110 and the terminal 120A may display, on the liquidation screen of multiple times of payments for Product A of FIG. 9C, for example, detailed information of the usage status of multiple times of payments for Product A such as the total amount already liquidated for the multiple times of payments for product A, the amount of debt for the multiple times of payments for product A, the interest rate, and the like.

When the “list product” button 923A or the “list product and liquidate with sales amount” button 923B of FIG. 9C is pressed by User A, the terminal 120A displays the listing screen 931 of Product A of FIG. 9D. If Product A is listed by pressing the “list product and liquidate with sales amount” button 923B by User A, the server 110 may allocate the sales amount to liquidate the debt for multiple times of payments for Product A when Product A is sold. In this case, if the sales amount is larger than the amount of the debt, the server 110 adds the difference between the sales amount and the amount of the debt to the sales amount of User A stored in the user information storage unit 3151. For example, the server 110 liquidates the debt of User A for Product A by setting the outstanding balance for Product A to 0 yen, which is included in the multiple times of payments usage information of User A stored in the deferred payment information storage unit 3152. Furthermore, if the sales amount is smaller than the amount of the debt, the server 110 reduces the sales amount from the outstanding balance for Product A included in the multiple times of payments usage information of User A stored in the deferred payment information storage unit 3152. This allows the user to automatically liquidate at least part of the debt when listed Product A is purchased.

In the example of FIG. 9D, the terminal 120A displays, on the listing screen of product A, the information of Product A such as images 916A, 931A, 931B, a product name 932, a product description 933, a category 934, and price 935 of Product A purchased by the multiple times of payments, and the “list product” button 936. The terminal 120A may acquire and display the information of Product A stored in the product information storage unit 3153 in association with User A from the server 110. The terminal 120A may set the estimated price 922 calculated by the server 110 to the price 935 as default. The terminal 120A may change the information of Product A by the operation of User A.

When the “list product” button 936 is pressed by User A, the terminal 120A transmits a listing product request to the server 110. Then, the server 110 registers the information of Product A in the purchasing/selling information storage unit 3154 and sets the transaction state to “listed”. This allows User A to list a product that is purchased by multiple times of payments and left with the debt for deferred payment, in the transaction service.

### (Benefit Giving Process)

Subsequently, the terminal 120A receives a predetermined operation for using the transaction service provided by the server 110 from User A (step S108). Subsequently, the terminal 120A transmits a request corresponding to the received predetermined operation to the server 110 (step S109).

Subsequently, the server 110 executes a process using a transaction service corresponding to the received request (step S110). Subsequently, the server 110 gives User A a benefit related to the liquidation of debt for multiple times of payments for Product A based on the information related to the purchasing/selling of User A by using the transaction service (step S111). For example, the server 110 may give User A, as a benefit, points available for liquidating debt for multiple times of payments for Product A in the payment service provided by the server 110. In this case, the server 110 may give a predetermined amount of points to the balance of User A stored in the user information storage unit 3151.

Furthermore, the server 110 may reduce the debt of User A for multiple times of payments as a benefit. In this case, the server 110 may reduce the outstanding balance included in the multiple times of payments usage information of User A stored in the deferred payment information storage unit 3152. Furthermore, for example, the server 110 may give User A, as a benefit, a coupon which can receive a discount on the price, a reduction in the interest rate (preferential interest rate), or the like in the case of purchasing a product by multiple times of payments under predetermined conditions.

Furthermore, the server 110 may give (return) User A, as a benefit, such as points equivalent to at least a part of the amount collected as the interest rate fee of multiple times of payments for product A.

Next, an example of the process of giving a benefit to User A in steps S108 to S111 of FIG. 7 will be described.

((Giving a Benefit for Liquidating with Sales Amount))

The server 110 may give a benefit to User A when User A uses at least a part of the sales amount obtained by selling the product in the transaction service to liquidate at least a part of the debt due to deferred payment. For example, this allows motivating the user to repay the debt due to deferred payment early. Furthermore, the user can be motivated to sell the product in the transaction service and obtain the sales amount.

Furthermore, the server 110 may give User A a benefit corresponding to the sales amount used for the liquidation by User A. For example, if a sales amount of 3,000 yen is used for liquidation, points equivalent to 150 yen which is 5% of the sales amount may be given to the balance of User A stored in the user information storage unit 3151.

Furthermore, when the “early liquidation” button 923D is pressed by User A, the server 110 may display on the terminal 120A the display screen for liquidating the debt for Product A by using (consuming) at least one of sales amounts, points, and a deposit balance. Then, if the operation liquidating the debt for Product A by using the sales amount is performed by User A, a benefit may be given to User A.

### ((Giving a Benefit for Listing in a Transaction Service))

The server 110 may give a benefit to User A when User A lists a product, for which debt for deferred payment remains, by using a transaction service provided by the server 110. For example, this allows motivating the user to list, by using a transaction service, a product for which the debt for deferred payment remains, for repaying the debt for deferred payment early.

Furthermore, the server 110 may give a benefit corresponding to the value of the product to User A when the product for which debt for deferred payment remains is listed by using a transaction service provided by the server 110. In this case, for example, if the purchase price of the product is 6000 yen, the server 110 may give such as points of 5% of the purchase price, which is 300 yen, to the balance of User A stored in the user information storage unit 3151. The value of the product may be the value of the product in the transaction service. In this case, for example, if the value of the product in the transaction service is 3000 yen, the server 110 may give such as points of 5% of the purchase price, which is 150 yen, to the balance of User A stored in the user information storage unit 3151.

The server 110 may calculate the salable amount of the product estimated based on the transaction history (purchasing/selling history) in the transaction service as the value of the product in the transaction service. In this case, the server 110 may calculate the representative value of the same product as the product designated by User A or the product whose similarity to the product designated by User A is equal to or more than a predetermined threshold (similar), by referring to the purchasing/selling information storage unit 3154, and may estimate the representative value as a salable amount. The server 110 may use, for example, a mean value, a median, or a mode as the representative value.

The server 110 may determine that the product designated by User A and the product stored in the purchasing/selling information storage unit 3154 are the same when both products match a product name, a brand, a color of the product, and a size of the product. Furthermore, for example, the server 110 may determine that the similarity between the product designated by User A and the product stored in the purchasing/selling information storage unit 3154 is equal to or greater than the predetermined threshold, when both products have a predetermined relationship which is set in advance regarding a category, and at least a part of the product name and the brand of both products matches. Furthermore, for example, the server 110 may calculate the similarity of both products based on the fixed price of the product, the purchased/sold price in the transaction service, the product name, the brand, the color, the size, or the like, by using AI through which the machine learning is performed by deep learning or the like.

### ((Giving a Benefit for Purchasing/Selling in a Transaction Service))

The server 110 may give a benefit to User A when a product, for which debt for deferred payment remains, is sold by User A using the transaction service provided by the server 110. For example, this allows motivating the user to sell, by using the transaction service, a product for which the debt for deferred payment remains, for repaying the debt for deferred payment early.

In this case, when the “list product and liquidate with sales amount” button 923B is pressed by User A and listed Product A is purchased by the purchaser, the server 110 may offset the sales amount of Product A and the debt for multiple times of payments for product A. For example, this allows simplifying the operation by the user for repaying the debt for deferred payment. Furthermore, in this case, the server 110 may give User A a benefit corresponding to the interest rate fee of multiple times of payments for product A. For example, the server 110 may give such as points equivalent to a predetermined amount (for example, 300 yen) or less among the amounts already collected from user A as interest rate fees of multiple times of payments for Product A, to the balance of User A stored in the user information storage unit 3151.

Furthermore, the server 110 may give a benefit corresponding to the price at the time of sale to User A when a product, for which debt for deferred payment remains, is sold by User A using the transaction service provided by the server 110. In this case, for example, if the sold price of the product in the transaction service is 3,000 yen, the commission is 300 yen, and the sales amount is 2,700 yen (=3,000 yen−300 yen), the server 110 may give such as points equivalent to 135 yen which is 5% of the sales amount to the balance of User A stored in the user information storage unit 3151.

With respect to the previously described, the following items will be further disclosed.

Further, the present invention is not limited to these embodiments, but various variations and modifications may be made without departing from the scope scope of the present invention.

### (Clause 1-1)

An information processing method to be executed by an information processing apparatus, comprising:

providing a deferred payment service that includes a lump-sum payment to be liquidated in lump-sum within a predetermined period, and multiple times of payments to be liquidated respectively on a plurality of dates including a date within the predetermined period and dates after the predetermined period;

receiving information of a first maximum amount to be liquidated by the deferred payment service within the predetermined period, designated by a user; and

setting a second maximum amount, to be liquidated by one payment of the multiple times of payments, at or below a predetermined ratio of the first maximum amount.

### (Clause 1-2)

The information processing method according to Clause 1-1, further comprising setting an amount obtained by subtracting the second maximum amount from a maximum amount to be liquidated by the deferred payment service within the predetermined period, as a maximum amount to be liquidated by the lump-sum payment.

### (Clause 1-3)

The information processing method according to Clause 1-1 or 1-2, further comprising determining a limit amount of debt available for the deferred payment service based on information of the user.

### (Clause 1-4)

The information processing method according to Clause 1-3, further comprising setting an amount obtained by subtracting the maximum amount to be liquidated by the deferred payment service within the predetermined period from the limit amount of debt available for the deferred payment service, as a limit amount of debt available for the multiple times of payments.

### (Clause 1-5)

The information processing method according to any one of Clause 1-1 to 1-4, wherein the predetermined ratio is determined based on information of the user.

### (Clause 1-6)

The information processing method according to any one of Clause 1-1 to 1-5, further comprising permitting use of the multiple times of payments if a price of a product purchased by the user is equal to or more than a predetermined amount.

### (Clause 1-7)

The information processing method according to any one of Clause 1-1 to 1-6, further comprising restricting use of the multiple times of payments based on a type of product purchased by the user.

### (Clause 1-8)

An information processing apparatus comprising a control unit configured to:

provide a deferred payment service that includes a lump-sum payment to be liquidated in lump-sum within a predetermined period, and multiple times of payments to be liquidated respectively on a plurality of dates including a date within the predetermined period and dates after the predetermined period;

receive information of a first maximum amount to be liquidated by the deferred payment service within the predetermined period, designated by a user; and

set a second maximum amount, to be liquidated by one payment of the multiple times of payments, at or below a predetermined ratio of the first maximum amount.

### (Clause 1-9)

A computer-readable non-transitory storage medium storing a program for causing an information processing apparatus to execute processing of:

providing a deferred payment service that includes a lump-sum payment to be liquidated in lump-sum within a predetermined period, and multiple times of payments to be liquidated respectively on a plurality of dates including a date within the predetermined period and dates after the predetermined period;

receiving information of a first maximum amount to be liquidated by the deferred payment service within the predetermined period, designated by a user; and

setting a second maximum amount, to be liquidated by one payment of the multiple times of payments, at or below a predetermined ratio of the first maximum amount.

### (Clause 1-10)

A computer-readable non-transitory storage medium storing storing a program for causing an information processing terminal to execute processing of:

using, provided by an information processing apparatus, a deferred payment service that includes a lump-sum payment to be liquidated in lump-sum within a predetermined period, and multiple times of payments to be liquidated respectively on a plurality of dates including a date within the predetermined period and dates after the predetermined period;

accepting an input of a first maximum amount to be liquidated by the deferred payment service within the predetermined period, from a user; and

setting a second maximum amount, to be liquidated by one payment of the multiple times of payments, at or below a predetermined ratio of the first maximum amount.

### (Clause 1-11)

An information processing terminal comprising a control unit configured to:

use, provided by an information processing apparatus, a deferred payment service that includes a lump-sum payment to be liquidated in lump-sum within a predetermined period, and multiple times of payments to be liquidated respectively on a plurality of dates including a date within the predetermined period and dates after the predetermined period;

accept an input of a first maximum amount to be liquidated by the deferred payment service within the predetermined period, from a user; and

set a second maximum amount, to be liquidated by one payment of the multiple times of payments, at or below a predetermined ratio of the first maximum amount.

### (Clause 1-12)

An information processing method to be executed by an information processing terminal, comprising:

using, provided by an information processing apparatus, a deferred payment service that includes a lump-sum payment to be liquidated in lump-sum within a predetermined period, and multiple times of payments to be liquidated respectively on a plurality of dates including a date within the predetermined period and dates after the predetermined period;

accepting an input of a first maximum amount to be liquidated by the deferred payment service within the predetermined period, from a user; and

setting a second maximum amount, to be liquidated by one payment of the multiple times of payments, at or below a predetermined ratio of the first maximum amount.

### (Clause 2-1)

An information processing method to be executed by an information processing device, comprising:

settling price for a first product purchased by a user by a deferred payment service of multiple times of payments;

providing a transaction service that performs purchasing/selling a product, to the user; and

giving a benefit related to liquidation of debt for the multiple times of payments regarding the first product, based on information related to the purchasing/selling by the user using the transaction service.

### (Clause 2-2)

The information processing method according to Clause 2-1, wherein providing a transaction service comprises giving a first sales amount to the user by selling a product using the transaction service, wherein giving a benefit comprises giving the benefit to the user when at least a part of the first sales amount is used for the liquidation of the debt for the multiple times of payments regarding the first product.

### (Clause 2-3)

The information processing method according to Clause 2-2, wherein giving a benefit comprises giving a benefit corresponding to an amount used for the liquidation when at least a part of the first sales amount is used for the liquidation of the debt for the multiple times of payments regarding the first product.

### (Clause 2-4)

The information processing method according to any one of Clause 2-1 to 2-3, wherein giving a benefit comprises giving the benefit when the first product is listed by the user by using the transaction service.

### (Clause 2-5)

The information processing method according to Clause 2-4, wherein giving a benefit comprises giving a benefit corresponding to a value of the first product in the transaction service when the first product is listed by the user by using the transaction service.

### (Clause 2-6)

The information processing method according to any one of Clause 2-1 to 2-5, wherein giving a benefit comprises giving a benefit corresponding to a price of the first product at the time of sale when the first product is sold by the user by using the transaction service.

### (Clause 2-7)

The information processing method according to any one of Clause 2-1 to 2-6, wherein the benefit includes at least one of points available for settlement service, reduction of the debt of the multiple times of payments, and discount or reduction of interest rate when a product is purchased by using a deferred payment service of the multiple times of payments.

### (Clause 2-8)

An information processing apparatus comprising a control unit configured to:

settle price for a first product purchased by a user by deferred payment service of multiple times of payments;

provide a transaction service that performs purchasing/selling a product, to the user; and

give a benefit related to liquidation of debt for the multiple times of payments regarding the first product, based on information related to the purchasing/selling by the user using the transaction service.

### (Clause 2-9)

A computer-readable non-transitory storage medium storing a program for causing an information processing apparatus to execute processing of:

settling price for a first product purchased by a user by a deferred payment service of multiple times of payments;

providing a transaction service that performs purchasing/selling a product, to the user; and

giving a benefit related to liquidation of debt for the multiple times of payments regarding the first product, based on information related to the purchasing/selling by the user using the transaction service.

### (Clause 2-10)

A computer-readable non-transitory storage medium storing a program for causing an information processing terminal to execute processing of:

settling, provided by an information processing apparatus, price for a first product purchased by a user by a deferred payment service of multiple times of payments;

using, provided by the information processing apparatus, a transaction service that performs purchasing/selling a product, by the user; and

acquiring a benefit for the user, related to liquidation of debt for the multiple times of payments regarding the first product, based on information related to the purchasing/selling by the user using the transaction service.

### (Clause 2-11)

An information processing terminal comprising a control unit configured to:

settle, provided by an information processing apparatus, price for a first product purchased by a user by a deferred payment service of multiple times of payments;

use, provided by the information processing apparatus, a transaction service that performs purchasing/selling a product, by the user; and

acquire a benefit for the user, related to liquidation of debt for the multiple times of payments regarding the first product, based on information related to the purchasing/selling by the user using the transaction service.

### (Clause 2-12)

An information processing method to be executed by an information processing terminal, comprising:

settling, provided by an information processing apparatus, price for a first product purchased by a user by a deferred payment service of multiple times of payments;

using, provided by the information processing apparatus, a transaction service that performs purchasing/selling a product, by the user; and

acquiring a benefit for the user, related to liquidation of debt for the multiple times of payments regarding the first product, based on information related to the purchasing/selling by the user using the transaction service.

### (Clause 3-1)

An information processing method to be executed by an information processing device, comprising:

collecting an amount to be liquidated by one revolving credit from a balance of a user;

allocating the collected amount to liquidation of debt for the revolving credit regarding at least one of a first product and a second product purchased by the revolving credit; and

transmitting information displaying a liquidation status regarding the first product and a liquidation status regarding the second product by the revolving credit, to an information processing terminal used by the user.

### (Clause 3-2)

The information processing method according to Clause 3-1, wherein allocating comprises allocating the collected amount to liquidation of the debt in order of at least one of early purchase date and time, high price at the time of purchase, and high interest rate set, of the first product and the second product.

### (Clause 3-3)

The information processing method according to Clause 3-1 or 3-2, wherein allocating comprises allocating the collected amount equally to liquidation of the revolving credit regarding the first product and to liquidation of the revolving credit regarding the second product.

### (Clause 3-4)

The information processing method according to any one of Clause 3-1 to 3-3, wherein allocating comprises allocating the collected amount respectively, corresponding to purchase price of the first product and purchase price of the second product, to liquidation of the revolving credit regarding the first product and to liquidation of the revolving credit regarding the second product.

### (Clause 3-5)

The information processing method according to any one of Clause 3-1 to 3-4, further comprising:

restricting use of new revolving credit, if the debt of the revolving credit remains for predetermined number or more of products.

### (Clause 3-6)

The information processing method according to any one of Clause 3-1 to 3-5, further comprising:

permitting settlement for price of the first product by the revolving credit, if price of the first product purchased by using a transaction service is equal to or more than a predetermined amount; and

restricting settlement for price of the first product by the revolving credit, if the price of the first product is not equal to or more than a predetermined amount.

### (Clause 3-7)

The information processing method according to any one of Clause 3-1 to 3-6, further comprising:

storing information of the first product in association with the user, if the first product is purchased by the user; and

listing the first product using the stored information of the first product, if the first product is listed in the transaction service by the user.

### (Clause 3-8)

The information processing method according to Clause 3-7, further comprising allocating a sales amount by sale to liquidation of the revolving credit regarding the first product, if the first product listed in the transaction service by the user is sold.

### (Clause 3-9)

The information processing method according to Clause 3-7, further comprising giving a benefit corresponding to an interest rate fee of the revolving credit to the user, if the first product listed in the transaction service by the user is sold.

### (Clause 3-10)

An information processing apparatus comprising a control unit configured to:

collect an amount to be liquidated by one revolving credit from a balance of a user;

allocate the collected amount to liquidation of debt for the revolving credit regarding at least one of a first product and a second product purchased by the revolving credit; and

transmit information displaying a liquidation status regarding the first product and a liquidation status regarding the second product by the revolving credit, to an information processing terminal used by the user.

### (Clause 3-11)

A computer-readable non-transitory storage medium storing a program for causing an information processing apparatus to execute processing of:

collecting an amount to be liquidated by one revolving credit from a balance of a user;

allocating the collected amount to liquidation of debt for the revolving credit regarding at least one of a first product and a second product purchased by the revolving credit; and

transmitting information displaying a liquidation status regarding the first product and a liquidation status regarding the second product by the revolving credit, to an information processing terminal used by the user.

### (Clause 3-12)

A computer-readable non-transitory storage medium storing a program for causing an information processing terminal to execute processing of:

purchasing, in response to an operation of a user, a first product using a revolving credit provided by an information processing apparatus;

purchasing, in response to an operation of the user, a second product using the revolving credit; and

displaying a liquidation status regarding the first product and a liquidation status regarding the second product,

wherein, an amount to be liquidated by one revolving credit is collected from a balance of a user, which is allocated to liquidation of debt for the revolving credit regarding at least one of the first product and the second product.

### (Clause 3-13)

An information processing terminal comprising a control unit configured to:

purchase, in response to an operation of a user, a first product using a revolving credit provided by an information processing apparatus;

purchase, in response to an operation of the user, a second product using the revolving credit; and

display a liquidation status regarding the first product and a liquidation status regarding the second product,

wherein, an amount to be liquidated by one revolving credit is collected from a balance of a user, which is allocated to liquidation of debt for the revolving credit regarding at least one of the first product and the second product.

### (Clause 3-14)

An information processing method to be executed by an information processing terminal, comprising:

purchasing, in response to an operation of a user, a first product using a revolving credit provided by an information processing apparatus;

purchasing, in response to an operation of the user, a second product using the revolving credit; and

displaying a liquidation status regarding the first product and a liquidation status regarding the second product,

wherein, an amount to be liquidated by one revolving credit is collected from a balance of a user, which is allocated to liquidation of debt for the revolving credit regarding at least one of the first product and the second product.

The present application is based on and claims priority to Japanese patent application No. 2019-168153 filed on Sep. 17, 2019, with the Japanese Patent Office, the entire contents of which are hereby incorporated by reference.

What is claimed is:

1. An information processing method to be executed by an information processing apparatus, comprising:
providing a deferred payment service that includes a lump-sum payment to be liquidated in lump-sum within a predetermined period, and multiple times of payments to be liquidated respectively on a plurality of dates including a date within the predetermined period and dates after the predetermined period;
receiving information of a first maximum amount to be liquidated by the deferred payment service within the predetermined period, designated by a user; and
setting a second maximum amount, to be liquidated by one payment of the multiple times of payments, at or below the first maximum amount.

2. The information processing method according to claim 1, further comprising setting an amount obtained by subtracting the second maximum amount from a maximum amount to be liquidated by the deferred payment service within the predetermined period, as a maximum amount to be liquidated by the lump-sum payment.

3. The information processing method according to claim 1, further comprising determining a limit amount of debt available for the deferred payment service based on information of the user.

4. The information processing method according to claim 3, further comprising setting an amount obtained by subtracting the maximum amount to be liquidated by the deferred payment service within the predetermined period from the limit amount of debt available for the deferred payment service, as a limit amount of debt available for the multiple times of payments.

5. The information processing method according to claim 1, further comprising setting the second maximum amount at or below a predetermined ratio of the first maximum amount, wherein the predetermined ratio is determined based on information of the user.

6. The information processing method according to claim 1, further comprising permitting use of the multiple times of payments if a price of a product purchased by the user is equal to or more than a predetermined amount.

7. The information processing method according to claim 1, further comprising restricting use of the multiple times of payments based on a type of product purchased by the user.

8. An information processing apparatus comprising a control unit configured to:
provide a deferred payment service that includes a lump-sum payment to be liquidated in lump-sum within a predetermined period, and multiple times of payments to be liquidated respectively on a plurality of dates including a date within the predetermined period and dates after the predetermined period;
receive information of a first maximum amount to be liquidated by the deferred payment service within the predetermined period, designated by a user; and
set a second maximum amount, to be liquidated by one payment of the multiple times of payments, at or below the first maximum amount.

9. A computer-readable non-transitory storage medium storing a program for causing an information processing terminal to execute processing of:
using, provided by an information processing apparatus, a deferred payment service that includes a lump-sum payment to be liquidated in lump-sum within a predetermined period, and multiple times of payments to be liquidated respectively on a plurality of dates including a date within the predetermined period and dates after the predetermined period;
receiving an input of a first maximum amount to be liquidated by the deferred payment service within the predetermined period, from a user; and
setting a second maximum amount, to be liquidated by one payment of the multiple times of payments, at or below the first maximum amount.
